(19) United States
(12) Patent Application Publication
(10) Pub. No.: US 2026/0070029 A1
(43) Pub. Date: Mar. 12, 2026

(54) METHOD AND APPARATUS FOR PASSIVE MIXING OF MULTIPHASE FLOW

(71) Applicant: SRAVATHI ADVANCE PROCESS TECHNOLOGIES PRIVATE LIMITED, Bengaluru (IN)

(72) Inventors: Sreeramagiri Venkata Shanmukha SOURI, Bangalore (IN); Chungikar Abbas SOHEL, Bangalore (IN); Sreeramagiri SIVAKUMAR, Bangalore (IN); Anapat SAMIR, Bangalore (IN)

(21) Appl. No.: 19/107,599

(22) PCT Filed: Sep. 25, 2023
(86) PCT No.: PCT/IB2023/059443

§ 371 Date: Feb. 28, 2025

(30) Foreign Application Priority Data
Sep. 30, 2022 (IN) 20224156411

(51) Int. Cl. B01F 25/431; B01F 25/432; B01F 101/00

(52) U.S. Cl. CPC B01F 25/4317; B01F 25/432; B01F 2101/2204; B01F 2215/0422; B01F 2215/0431

(57) ABSTRACT

Method and Apparatus for passive mixing of a multiphase flow or hydrodynamic performance that is housing a conduit/tube, which is a channel extending internally from the fluid inlet to the outlet ports, comprising axially stacked plurality of static mixers possessing structural elements or mixing elements (possessing structural elements on their inner walls), that are responsible for continuous splitting, and combining of the flow through the conduit, bringing about enhanced mixing of the contents of the flow, mass-transfer, and heat transfer. The structural elements bring about an enhanced mixing of multi-phasic systems passing through the conduit such as liquid-liquid, liquid-gas-liquid, and systems comprising immiscible and viscous liquids. The mixing elements or structural elements are responsible for splitting of flow into sections of multiple streams, followed by forced recombination of the multiple streams which is responsible for the equitable dispersion of individual components of multiphasic flow, thereby enhancing mixing of flow.

### RELATED APPLICATIONS

This invention claims the benefit of priority to the Indian provisional application with the application No. 202241056411 filed on 30 Sep. 2022, titled “Method and apparatus for passive mixing of multiphase flow” and it is hereby incorporated in its entirety for reference sake.

### FIELD OF THE INVENTION

The invention relates to apparatus comprising of stacked plurality of static-mixers possessing structural elements that are responsible for passive mixing of a multiphase flow and more particularly to apparatus comprising of stacked plurality of static-mixers possessing structural elements that are responsible for passive mixing of a multiphase flow in turn the enhancement of heat transfer and mass-transfer by way of splitting and combining the multiphasic flow in a conduit.

### BACKGROUND OF THE INVENTION

Static mixers find application in a wide range of process operations, including dosing, dispersion, laminar flow heat exchange and emulsion formation. They find extensive application wherein combining of liquids, gases and powders is needed. Static-mixers are employed in homogeneous, heterogeneous, biphasic, multiphasic systems such as liquid-liquid, liquid-solid, liquid-liquid-gas for obtaining better mass transfer and heat transfer, better yields, and purity of the end-products in reaction engineering. They offer a maintenance-free mixing action since they are motionless and are without movable parts. Static mixers are often placed in a channel or conduit that is defined by a wall and provided with inlets and outlets for the reaction mixture to enter and exit, in a jacket or outer casing.

The mixing action in a static mixer is accomplished by way of fixing suitable structural elements on the inner walls of individual static mixer or by modifying the geometry of the individual static mixer, or by both. The efficiency of mixing and in turn yields obtained from a static mixer are mainly dependent on the mechanism by which the mixing action is brought about by the particular static mixer. One of the efficient ways of achieving the mixing action is by the continuous splitting of the flow with the help of the introduction of various structural elements, on the inner walls of the individual static mixers that are present in the conduit and further recombining of the individual streams. Thus, the motionless mixing or passive mixing of the flow is achieved by the use of a series of precisely configured mixing elements to process the components, extension, and transportation of the components. The splitting and recombining of a multiphasic flow play an important role in ensuring a thorough mixing of the different phases especially in case of systems having liquid-gas, immiscible solvent systems, liquid-liquid-gas where there is a disparity in the densities of the different phases forming such systems.

Many prior art references can be cited in this connection to understand the importance of split and combine mode of mixing using static mixers.

U.S. Pat. No. 5,437,299 disclosed a system for maintaining representative multiphase flow through a conduit system having one or more branch conduits, wherein the said multiphase fluid flow comprises gas and liquid comprising, a main supply conduit including an approach section, (b) a branch conduit intersecting said supply conduit and a run section of said supply conduit, said run section and said branch conduit being operable to conduct multiphase fluid flow which has been split from said multiphase fluid flow in said approach section to at least one said branch conduit.

The patent publication, IN202121031526 described a robust intensified multiphase continuous flow microreactor wherein the main modular configurations involved screw conveyor (2a), 3D splitting-remixing (2b) and wall scraping (2c). All these modules are used in solitary mode and/in combinations arranged in vertical or horizontal and in series or parallel configuration with/without mixing mode as per the process requirement for critical operations.

Patent CA2723001 disclosed a flow dividing device for a multi-phase fluid that comprises a first component having a first density and a second component having a second density that is greater than the first density, the dividing device comprising: a feed conduit having a feed end and a discharge end with a plurality of distribution conduits fluidly coupled to the discharge end; wherein the distribution conduits are arranged symmetrically with respect to a longitudinal axis of the feed conduit; and a flow redistribution element fluidly coupled to or integrally formed from the feed conduit in a position upstream of the discharge end and configured to induce tangential momentum to the multi-phase fluid to thereby preferentially force at least some of the second component to an inner wall of the feed conduit.

WO2009137457 described multi-phase fluid split in a flow splitting device that includes a feed pipe in which a flow redistribution element induces tangential motion in the phases such that the denser phase is forced to redistribute around the periphery of the feed pipe. The so redistributed flow is then split into two or more distribution conduits that are typically perpendicular to the flow direction of the feed flow. Most typically, the feed pipe is in a vertical position.

US20080232190 disclosed a mixing element (1) which is used to invert and mix flowing materials in a flow channel wherein the said mixing element comprises an axially-symmetrical base body (1a) which has a longitudinal axis (A). The base body (1a) comprises an outward-facing surface (1k) in relation to the longitudinal axis (A) and a front surface (Im) on each end of the longitudinal axis (A), in addition to a plurality of guiding elements (1b), which are rigidly connected to the base body (1a) on the surface (1k) via a base surface (11). The guiding elements (1b) are extended in a transversal manner in relation to the longitudinal axis (A), such that each guiding element (1b) comprises an inward-facing guiding surface (1d) in relation to the longitudinal axis (A) and an outward-facing guiding surface (1c) in relation to the longitudinal axis (A). A plurality of guiding elements (1b) is arranged in a successive manner in the direction of the periphery (A1) of the longitudinal axis (A).

F. Theron and N. LeSauze compared the performances of three different static mixers in terms of pressure drop generated by both single-phase flow and liquid-liquid flow in turbulent flow regime and in terms of emulsification performances. The three motionless mixers compared are the well-known SMX™ and SMV™ and the new version of the SMX called SMXPlus™. The study highlighted the influence of the dispersed phase concentration and some of the geometrical parameters such as number of elements and design of the motionless mixer on droplets size distributions characteristics. Finally, experimental results are correlated in terms of Sauter mean diameter as a function of hydrodynamic dimensionless numbers (International Journal of Multiphase Flow, Volume 37, Issue 5, June 2011, Pages 488-500).

Pankaj Srivastava et al. studied flow and heat transfer characteristics in convergent-divergent (CD) shaped microchannel with ribs and cavities. They found that the usage of CD shape with ribs and cavities can reduce the overall thermal resistance up to 40% and make the bottom surface temperature quite uniform. This heat transfer enhancement is mainly due to interruption and redevelopment of boundary-layers along with recirculation zone. The results also show that increasing Re leads to an enhanced heat transfer in terms of increased averaged Nusselt number from 15% to 46%. The combined effect of CD shape with RC is quite effective in heat transfer augmentation but it gradually loses its effectiveness at large values of Re due to a high pressure drop penalty (INTERNATIONAL JOURNAL OF HEAT AND TECHNOLOGY, Vol. 35, No. 4, December 2017, pp. 863-873).

Still there are lots of gaps to be closed in the field of static-mixers with split and combine mode to obtain intensified mixing efficiency especially in the case of multiphasic flow. Keeping these points in mind the instant invention of “Method and apparatus for passive mixing of Multiphase flow” is taken up. The exemplary aspects of various embodiments of the invention are disclosed in the summary of the invention and all the essential aspects relating the various embodiments of the invention are described in a detailed manner in the following paragraphs with specific references towards the corresponding figures as given hereunder. All the prior art references are incorporated hereby in their entirety and for reference-sake and in no way taking away the novelty of the instant invention. The various aspects of the invention disclosed here are definitely an improvement over the existing prior art and further stress upon the inventorship, novelty and applicability of the instant invention in the field of intensification of passive mixing ability of static mixers that operate in split and combine mode.

### BRIEF DESCRIPTION OF FIGURES

Various aspects of the embodiments are discussed below with reference to the accompanying figures, which are not necessarily drawn to scale, The figures are included to provide an illustration and a further understanding of the various aspects and embodiments, and are incorporated in, and constitute a part of this specification, but are not intended as a definition of the limits of any particular embodiment. The figures, together with the remainder of the specification, serve only to explain principles and operations of the described and claimed aspects and embodiments, but are not to be construed as limiting embodiments. In the figures, each identical or nearly identical component that is illustrated in various figures is represented by a like numeral. For purposes of clarity, not every component may be labelled in every figure.

FIG. 1 depicts the 3D image of the apparatus with split and combine-means for intensifying the multi-phasic flow.

FIG. 2 depicts the cross-sectional view of the apparatus comprising the assembly of stacked static mixers wherein each individual static mixer possesses six limbed axisymmetric cap like structural elements, and their arrangement in a conduit, wherein the splitting action is realized by way of the structural elements, showing the alternating splitting and combining zones. The 3D image of the Splitting pattern for static mixing of fluids is depicted herein. Alternating splitting and combining pattern is repeated through the length of the process side.

FIG. 3 depicts the cross-sectional view of the apparatus comprising the assembly of stacked static mixers wherein each individual mixer possesses axisymmetric divergent slope with a four-limbed cap like structural elements, and their arrangement in a conduit, wherein the splitting action is realized by way of the structural elements showing the alternating splitting and combining zones. The 3D image of the Splitting pattern for static mixing of fluids is depicted herein. Alternating splitting and combining pattern is repeated through the length of the process side.

FIG. 4 depicts the cross-sectional view of the apparatus comprising the assembly of stacked static mixers wherein each individual mixer possesses axisymmetric hubcap consisting of 3 supporting limbs like structural elements, and their arrangement in a conduit, wherein the splitting action is realized by way of the structural elements showing the alternating splitting and combining zones. The 3D image of the Splitting pattern for static mixing of fluids is depicted herein. Alternating splitting and combining pattern is repeated through the length of the process side.

FIG. 5 depicts the cross-sectional view of the apparatus comprising the assembly of stacked static mixers wherein each individual mixer possesses 3 arch like structures arranged around the axis of the pipe as the structural elements, and their arrangement in a conduit, wherein the splitting action is realized by way of the structural elements showing the alternating splitting and combining zones. The 3D image of the Splitting pattern for static mixing of fluids is depicted herein. Alternating splitting and combining pattern is repeated through the length of the process side.

FIG. 6 gives the Top and Bottom views of the embodiment as depicted first in FIG. 2 possessing axisymmetric divergent slope with a six-limbed cap.

FIG. 7 gives the Front view of the embodiment as depicted first in FIG. 2 possessing axisymmetric divergent slope with a six-limbed cap.

FIG. 8 gives the Top Isometric view of the embodiment as depicted first in FIG. 2 possessing axisymmetric divergent slope with a six-limbed cap.

FIG. 9 gives the Bottom isometric view of the embodiment as depicted first in FIG. 2 possessing axisymmetric divergent slope with a six-limbed cap.

FIG. 10 gives the: Section view showing the changing cross-section of the embodiment as depicted first in FIG. 2 possessing axisymmetric divergent slope with a six-limbed cap.

FIG. 11 gives the Front and simplified side views of the embodiment as depicted first in FIG. 3 possessing axisymmetric divergent slope with a four-limbed cap.

FIG. 12 gives the Isometric view of the embodiment as depicted first in FIG. 3 possessing axisymmetric divergent slope with a four-limbed cap.

FIG. 13 gives the Section views of the vertical section of the embodiment as depicted first in FIG. 3 possessing axisymmetric divergent slope with a four-limbed cap.

FIG. 14 gives the Section view showing the changing cross-section of the embodiment as depicted first in FIG. 3 possessing axisymmetric divergent slope with a four-limbed cap.

FIG. 15 gives the Front view of the embodiment as depicted first in FIG. 4 possessing axisymmetric hubcap consisting of 3 supporting limbs.

FIG. 16 gives the 3D-Isometric views of the embodiment as depicted first in FIG. 4 possessing axisymmetric hubcap consisting of 3 supporting limbs.

FIG. 17 gives the Trimetric views of the embodiment as depicted first in FIG. 4 possessing axisymmetric hubcap consisting of 3 supporting limbs.

FIG. 18 gives the Section views of the embodiment as depicted first in FIG. 4 possessing axisymmetric hubcap consisting of 3 supporting limbs.

FIG. 19 gives the Section view showing the changing cross-section of the embodiment as depicted first in FIG. 4 possessing axisymmetric hubcap consisting of 3 supporting limbs.

FIG. 20 gives the Exit region of the embodiment of the invention as depicted first in FIG. 5 possessing 3 arch like structures arranged around the axis of the pipe.

FIG. 21 gives the Cut section of the embodiment of the invention as depicted first in FIG. 5 possessing 3 arch like structures arranged around the axis of the pipe.

FIG. 22 gives the Transformation of the fluid cross-section of the embodiment of the invention as depicted first in FIG. 5 possessing 3 arch like structures arranged around the axis of the pipe.

FIGS. 2,3,4 and 5 depict the cross-sectional views of the apparatus disclosed by the invention with split and combine means for enhancing the mixing efficiency of passive flow, wherein an assembly of the stacked individual static mixers are arranged in a conduit or tube forming a channel between the inlet ports and the outlet port, wherein the mixing action is enhanced due to the structural elements present in the individual static mixers that are stacked together in the conduit.

### OBJECTIVES OF THE INVENTION

1. To come out with an apparatus for the intensification of passive mixing of a multiphasic flow, by way of introducing structural elements or mixing elements on the inner walls of the static mixer that can enhance the passive mixing, of a multiphasic flow by splitting the flow into various streams and recombining them, ensuring a thorough mixing of the multiphasic flow.
2. To come out with an apparatus and a method for the intensification of passive mixing of a multiphasic flow by way of introducing limbed structural elements on the inner walls of the individual static mixers wherein the structural elements split and combine the multiphasic flow passively in such a way that the multiphasic flow experiences alternate splitting and combining in a conduit all along from the inlet port to the outlet port in a housing.
3. To come out with an apparatus for the intensification of passive mixing of multi-phasic systems such as liquid-liquid, liquid-liquid-gas, immiscible solvent systems etc to achieve higher yields, maximum purity of the final product by way of introduction of structural elements in individual static mixers that can be stacked in a conduit or tube responsible for splitting and combining of the multiphasic flow.

### SUMMARY OF THE INVENTION

The exemplary embodiment of the invention discloses a method and apparatus for passive mixing of a multi-phase flow or hydrodynamic performance by way of splitting and combining the multiphasic flow, that is housing a conduit/tube, which is a channel extending internally from the fluid inlet to the outlet ports, comprising stacked plurality of static mixers possessing structural elements or mixing elements on the inner walls of the individual static mixers that are responsible for alternate splitting and combining of flow through the conduit, bringing about a cumulative splitting and combining effect on the flow. The cumulative splitting and combining effect results in enhanced mixing of the multi-phasic flow. The conduit comprises of a plurality of axially stacked static mixers across the length of the conduit that can allow the fluid to pass through them continuously experiencing splitting and combining effect resulting in improved mixing, mass-transfer, and heat transfer.

One embodiment of the invention discloses stacked plurality of monolith static mixers possessing structural elements, in channel or conduit in a housing for the intensification of mixing in a multiphase flow in split and combine mode of operating for better mass-transfer, heat-transfer, better yield and purity of the end product resulting in an improved performance.

An exemplary embodiment of the invention discloses a stacked plurality of static mixers in a conduit wherein individual static-mixer possesses an axisymmetric cap with six limbs as the structural element, that splits the flow area for intensification of mixing of multiphase flow wherein the openings on the cap direct fluid after splitting into a collecting basin, that has guide vanes that induce further splitting which is followed by thorough mixing.

Yet another important embodiment of the invention discloses a stacked plurality of monolith static mixers in a conduit for mixing multiphase flow wherein individual static-mixer possesses an axisymmetric divergent slope with a four-limbed cap as the structural element that forces fluid towards the edges and into dedicated slots that split the flow region into 4 openings/sections and are eccentric to the pipe central axis.

One more embodiment of the invention discloses a stacked plurality of monolith static mixers in a conduit for mixing multiphase flow wherein each individual static-mixer possesses an axisymmetric hubcap consisting of 3 supporting limbs as the structural element that split the flow region into 3 openings/sections and are eccentric to the pipe central axis wherein each opening directs fluid into a U-shaped ramp that reverses the flow direction and causes the fluid to collide with incoming streams.

Yet another exemplary aspect of the invention discloses a stacked plurality of static mixers in a conduit for multiphase flow wherein individual static mixer consisting of 3 arch like structures arranged around the axis of the pipe as the structural element that splits the flow and then proceed to reduce down to smaller arch like structures which cause the flow to be squeezed and jet out of the exit of the mixer.

One important aspect of the invention discloses stacking of plurality of the static-mixers possessing structural elements on the inner walls of the individual static mixers that are responsible for the splitting of the multiphasic flow in a conduit in a housing.

One more aspect of the invention discloses the individual static mixer possessing structural elements responsible for splitting the multiphasic flow in a conduit according to any of the embodiments in the form of an insert for intensification of mixing of multiphase flow.

The various embodiments of the instant invention are described in details with the help of the accompanying drawings drawing inferences to the specific aspects of the individual embodiments of the invention in the following sections. The various embodiments of the instant invention of “Method and Apparatus for passive-mixing of multiphase flow” are described in detail drawing reference to the accompanying figures in the following paragraphs. The various embodiments of the invention clearly stress upon the novelty, inventorship and utility aspects of the instant invention compared to the prior art reported hitherto. A person with ordinary skill can easily understand and perform the invention easily. The different aspects of the instant invention as disclosed herein are only illustrative in nature and various other embodiments and working of the invention are possible within the scope of the invention without deviating from the essence of the invention.

### DETAILED DESCRIPTION OF THE INVENTION

The examples of the apparatus discussed herein are not limited in application to the details of construction and the arrangement of components set forth in the following description or illustrated in the accompanying drawings. It will be understood by one of skill in the art that the apparatus is capable of implementation in other embodiments and of being practiced or carried out in various ways. Examples of specific embodiments are provided herein for illustrative purposes only and are not intended to be limiting. Also, the phraseology and terminology used herein is for the purpose of description and should not be regarded as limiting.

Any references to examples, embodiments, components, elements or acts of the apparatus herein referred to in the singular may also embrace embodiments including a plurality, and any references in plural to any embodiment, component, element, or act herein may also embrace embodiments including only a singularity (or unitary structure). References in the singular or plural form are not intended to limit the presently disclosed apparatus, its components, acts, or elements.

The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. The various embodiments of invention are described in detail herein and the various aspects of the invention are disclosed below.

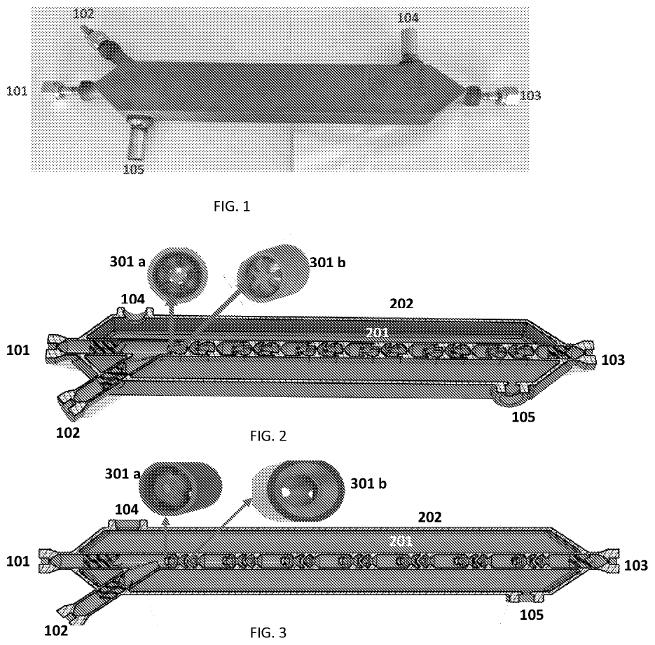

Drawing reference to FIG. 1, which clearly depicts the overall 3D image of the apparatus that is being used for intensifying the mixing in a multi-phasic flow that houses a conduit comprising stacked plurality of static mixers possessing structural elements that are responsible for alternate splitting and combining of flow through the conduit, bringing about the cumulative mixing effect on the flow. The cumulative mixing effect results in the enhanced mixing of the multi-phasic flow. FIG. 1 gives the overall picture of the apparatus housing a conduit/tube, the channel extending internally from the fluid inlet to the outlet ports comprising stacked plurality of static mixers. Here 101 & 102 indicate the process fluid(s) inlet ports, 103 indicates process fluid outlet port. 104 and 105 indicate utility fluid inlet and outlet ports respectively. The conduit comprises of a plurality of stacked static mixers across the length of the conduit that can allow the fluid to pass through them continuously experiencing a squeezing effect ensured by the individual static mixers whose geometry is suitably modified as is depicted in FIGS. 2 and 3.

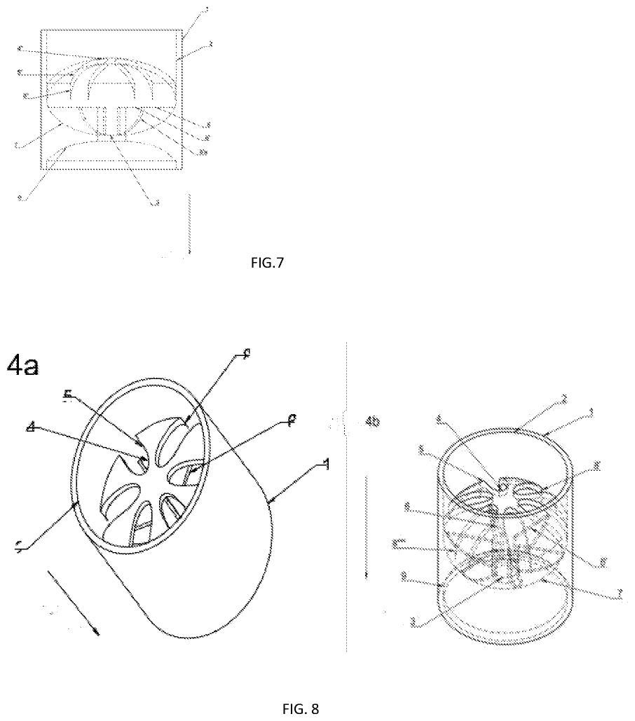

Drawing reference to FIG. 2, the specific embodiment shows the cross-sectional view of the apparatus comprising the stacked individual static mixers possessing axisymmetric cap with six limbs as the structural element wherein the assembly of stacked individual mixers and their arrangement in a conduit is depicted. Here the splitting action is realized by way of the axisymmetric cap with six limbs structure, showing the alternating splitting and combining zones. The dimensions of the conduit on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 200 mm; Inlet nozzle shape is circular in cross-section. On the utility side, the parameters are: thickness is 2 mm; width is 38 mm; Inlet and outlet nozzle diameter is 10 mm; shape is rectangular; The 3D image of the Splitting and combining pattern for static mixing of fluids is clearly depicted herein. The splitting and combining pattern is repeated throughout the length of the process side. Here 201 represents the Metal Wall of the inside tube containing static mixers and the flow volume for process fluid, whereas 202 is the outer casing of the wall. 301 a & b represent the blow-up images of the flow path through the static mixer possessing axisymmetric cap with six limbs. The unshaded area indicates the path for fluid flow. The specific embodiment of the invention as depicted in FIG. 2 is further described in detail drawing reference to FIGS. 6-10 that illustrate the specific aspects of the embodiment of the invention as illustrated for the first time in FIG. 2 in the following paragraphs.

Description of the Embodiment of the Invention as Depicted in FIG. 2 Wherein Individual Static Mixer Possesses an Axisymmetric Cap with Six Limbs as the Structural Element

### Description of Individual Static Mixer

The individual static mixer forming a part of the embodiment of the invention contained in FIG. 2 is a monolith static mixer for mixing multiphase flow comprising an axisymmetric cap that splits the flow area. This cap consists of 6 supporting limbs that split the flow region into 6 openings/sections and are eccentric to the pipe central axis. From the cap structure, each opening directs fluid into a collecting basin, that has guide vanes to further split the flow. The guide vanes are positioned such that fluid from adjacent openings is forced to mix after splitting. All the basins drain into a common central hole, that serves as a junction point for fluid from multiple channels to mix and flow out. Multiple Static mixers can be stacked axially to enhance the mixing and dispersion of the multiphase flow elements. Each successive mixer that is stacked can be oriented with the openings and guide vanes at an angular offset, to enhance the mixing. The basin drain is provided with a smooth, gradual ramp, leading to the circular pipe cross-section.

### Description of Flow

The flow regime initially gets split into the openings between the supports, when it encounters the cap. The circular flow cross-section is split into 6 smaller pockets by the cap and then opens into a collecting basin. Fluid from each of the openings is further split into 2 halves by centrally located vanes. Fluid split by adjacent vanes is forced to combine in shared collecting basins. Finally, all the fluid from various shared basins is forced to converge into the central drain hole, where they mix and flow out. The specific aspects of the invention as first depicted in FIG. 2 are further described in detail drawing reference to FIGS. 6-10 taking guidance parameters as given hereunder.

Description of Figures Related to the Embodiment of the Invention Comprising of an Axisymmetric Cap with Six Limbs as First Depicted in FIG. 2 (FIGS. 6-10)

The labels are common for all further images and represent the stated features for every static mixing unit as given hereunder. (Reference convention: feature labelled as 3 in FIG. 1a is to be referenced as 1a_3). The numbers given hereunder indicate the Label Entities against each such number as labelled in FIGS. 6-10 illustrating the specific aspects of the embodiment of the invention as first depicted in FIG. 2, wherein,
1 indicates Outer Diameter of the surrounding pipe of the static mixer that is cylindrical in nature;
2 indicates Inner Diameter of the surrounding pipe that is cylindrical in nature;
3 indicates Central drain hole;
4 indicates Curved surface of support/flow section;
5 denotes Straight edge of supports/flow section;
6 denotes Mid vane splitting flow in basin;
7 denotes Curved surface of the basin, directing flow to the central drain hole
8 denotes Vertical depth of support base;
9 denotes Curved ramp for additive manufacturing.

One aspect of the invention as first depicted in FIG. 2 is described in detail drawing reference to FIG. 6 wherein 1a gives Top view of the static mixer (as approached by the fluid, with flow direction into the paper). Shows the non-visible edges as dashed lines, which are labelled FIG. 1a_3). 1b gives Bottom view of the static mixer (as exited by the fluid, with flow direction out of the paper shows the non-visible edges as dashed lines, which are labelled in addition to the previous (FIG. 1b_4″,1b_5″,1b_6″).

Another aspect of the invention as first depicted in FIG. 2 is described in detail drawing reference to FIG. 7 that gives The Front view of the static mixer: Hidden edges (cross-section split and basin) are depicted as dashed lines. Flow direction is also shown and is along the length of the tube. Individual static mixer elements are stacked in succession to give enhanced mixing effects. This view shows the radial splitting of flow and recombination at the central drain (FIG. 7_3,7_7,7_8″).

One aspect of the invention as first depicted in FIG. 2 is described in detail drawing reference to FIG. 8: wherein 4a gives Top 3D isometric view of the static mixer. Flow direction is also shown and is along the length of the tube. This view gives a better understanding of the structure of the entry surface and the nature of its changes. From this view, primarily the three-dimensional nature of the upper cap along with the splitting of flow into sections and the mid-vanes can be observed (4a_4,4a_6). 4b gives a view of 4a projected onto the side plane, with hidden edges (internal) represented as dotted lines. Flow direction is also shown and is along the length of the tube. This view is to better visualize the 3D nature of the flow splitting and collecting basin (4b_6,4b_7,4b_8).

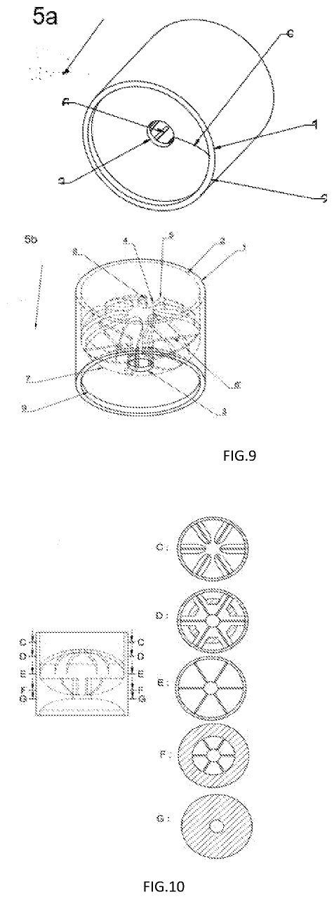

One aspect of the embodiment of the invention as first depicted in FIG. 2 is described in detail drawing reference to FIG. 9 wherein 5a gives Bottom isometric view of the static mixer. Flow direction is also shown and is along the length of the tube. This view gives a better understanding of the structure of the exit surface and the nature of its changes. From this view, primarily the three-dimensional nature of the collecting exit drain (5a_3) along with the converging ramp from the pipe section to the collecting drain (5a_9,5a_3) are in focus. 5b gives Left bottom trimetric view of the static mixer, with hidden edges depicted as dashed lines. Flow direction is also shown and is along the length of the tube. From this view, an improved 3D visualization of the collecting basin (5b_7) and the converging ramp (FIG. 5b_9) is observed.

One aspect of the embodiment of the invention as first depicted in FIG. 2 is described in detail drawing reference to FIG. 10 which gives the Section view showing the changing cross-section of the static mixer, from radial split to reconverging after the collecting basin. Here 5 Sections are made, that spread across the length of one mixer element. They are labelled as follows: Section C: Section at the inlet of the mixing element, showing the radial splitting of the cross-section from the top view. Section D: Section in the first half of the mixing element, showing a transition from the upper cap to an open expansion and recombining region post splitting. Section E: Mid-section of the mixer, showing the mid-vanes splitting flow in the collecting basin into distinct regions. Section F: Section in the second half of the mixer, showing the converging basin directing fluid toward the central drain. Section G: Final cross-section of the mixing element, showing the central drain through which, all fluid must pass.

Additional embodiments of the invention as first depicted in FIG. 2 are possible by varying the key aspects of the invention and are listed as given here: The entry length and the exit length of the mixer can be varied according to the intended working fluid; The aspect ratio of the initial cross-section to the subsections can be varied, as defined by the relation: Total area of the split in the upper cap/Area of initial cross-section; The upper cap can have n number of splits where n≥2; The cap centre and collecting drain can be eccentric or non-eccentric with the central axis; The cap openings (cross-section splits) can have an angle α, where 180°/n (close clutter)≤α≤360°/n (radially symmetric), and n is the number of splits; The mid-vanes can have a tapered edge or a flat edge; Mid-vane length can be anywhere between 0.2*r to 0.9*r, where r is the inner radius of the pipe; The central drain can have any cross-sectional shape, with side m≥3, circular, elliptical etc.; The upper cap and basin can have an angle of descent ranging from 20°≤μ<70° with the longitudinal axis of the pipe (defined by the angle between the central and radial extreme circumferences).

Description of the Embodiment of the Invention as First Depicted in FIG. 3 Wherein Individual Static Mixer Possesses an Axisymmetric Divergent Slope with a Four-Limbed Cap as the Structural Element

Drawing reference to FIG. 3, the specific embodiment shows the cross-sectional view of the apparatus comprising the stacked static mixers individually possessing axisymmetric divergent slope with a four-limbed cap as the structural element responsible for splitting and combining the flow wherein the assembly of stacked individual mixers and their arrangement in a conduit is depicted. Herein the splitting action is realized by way of the axisymmetric divergent slope with a four-limbed cap structure showing the alternating splitting and combining zones. The dimensions of the conduit on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 205 mm; Inlet nozzle shape is circular in cross-section. On the utility side, the parameters are: thickness is 2 mm; width is 38 mm; Inlet and outlet nozzle diameter is 10 mm; shape is rectangular; The 3D image of the Splitting and combining pattern for static mixing of fluids is clearly depicted herein. The splitting and combining pattern is repeated throughout the length of the process side. Here 201 represents the Metal Wall of the inside tube containing static mixers and the flow volume for process fluid, whereas 202 is the outer casing of the wall. 301 a & b represent the blow-up images of the flow path through the static mixer possessing axisymmetric divergent slope with a four-limbed cap. The unshaded area indicates the path for fluid flow. The important embodiment of the invention as depicted in FIG. 3 for the first time is further illustrated drawing reference to FIGS. 11-14 that illustrated the specific aspects of the invention as contained in FIG. 3 in a detailed manner in the following paragraphs.

Description of the Static Mixer Possessing an Axisymmetric Divergent Slope with a Four-Limbed Cap as the Structural Element

A monolith static mixer for mixing multiphase flow comprising an axisymmetric divergent slope that forces fluid towards the edges and into dedicated slots. This cap comprises of 4 limbs, that split the flow region into 4 openings/sections and are eccentric to the pipe central axis. Furthermore, there is a central plateau that helps force fluid radially, with a through hole in the centre that provides an alternate route for fluid. From the convergent sloped roof, there exists an inner radial slope, that forces fluid to converge to the centre from the edges. All fluid is forced through a small central hole. Multiple Static mixers can be stacked axially to enhance the mixing and dispersion of the multiphase flow elements. Each successive mixer that is stacked can be oriented with the openings and supports at an angular offset, to enhance the mixing. The radial slope is provided with a smooth, gradual ramp, leading to the circular pipe cross-section.

### Description of Flow

The flow regime initially gets split into the slots between the supports, when it encounters the divergent slope, additionally, some fluid flows straight through the hole located on the central plateau. The circular flow cross-section is split into 5 smaller pockets by the slope and then opens into a convergent slope. Fluid from each of the openings is made to interact by the radial slope, which forces all the fluid towards the central hole. In this manner, the fluid flowing straight through the plateau hole encounters fluid that was split by the divergent ring from all 4 directions and is forced through a smaller cross-section.

Description of Figures Related to the Embodiment as Illustrated in FIG. 3 for the First Time with Each Static-Mixer Possessing an Axisymmetric Divergent Slope with a Four-Limbed Cap as the Structural Element (FIG. 11-14)

The labels are common for all further images and represent the specific features of the embodiment as first depicted in FIG. 3 wherein each static mixer possessing an axisymmetric divergent slope with a four-limbed cap as the structural element and are illustrated in FIGS. 11-14. (Reference convention: feature labelled as 3 in FIG. 1a is to be referenced as 1a_3) The numbers given hereunder indicate the Label Entities against each such number as labelled in FIGS. 11-14 illustrating the specific aspects of the embodiment of the invention as first depicted in FIG. 32, wherein,
1 indicates Outer Diameter of the surrounding pipe of the static mixer that is cylindrical in nature;
2 indicates Inner Diameter of the surrounding pipe that is cylindrical in nature;
3 indicates Through hole located on the central plateau;
4 indicates Inner Curved surface of support/flow slots of the divergent slope;
5 indicates Straight edge of supports/flow slots of the divergent slope;
6 indicates Outer curved surface of supports/flow slots of the divergent slope;
7 indicates Innermost circumference of the radially convergent slope; 7a: Upper edge of the inner curve of the convergent slope. 7b: Lower edge of the inner curve of the convergent slope;
8 indicates Horizontal curved surface of the supports of the divergent slope, at the internal wall of the pipe; 8a: Edge of intersection between the divergent slope and the internal pipe of the wall;
9 denotes Beginning edge of the radial convergent slope. 10 Outer radius of the central plateau.

One aspect of the invention as depicted for the first time FIG. 3 is further illustrated drawing reference to FIG. 11: Here 2a gives the Front view of the static mixer. Hidden edges (cross-section split and basin) are depicted as dashed lines. Flow direction is also shown and is along the length of the tube. Individual static mixer elements are stacked in succession to give enhanced mixing effects. This view shows the radial splitting of flow through the slots and central convergence (2a_3,2a_4,2a_7,2a_9). 2b gives the simplified Side view of the static mixer. Hidden (cross-section split and basin) are depicted as dashed lines. Flow direction is also shown and is along the length of the tube. This simplified view only shows the functional aspects of the mixer. (2b_7,2b_8)

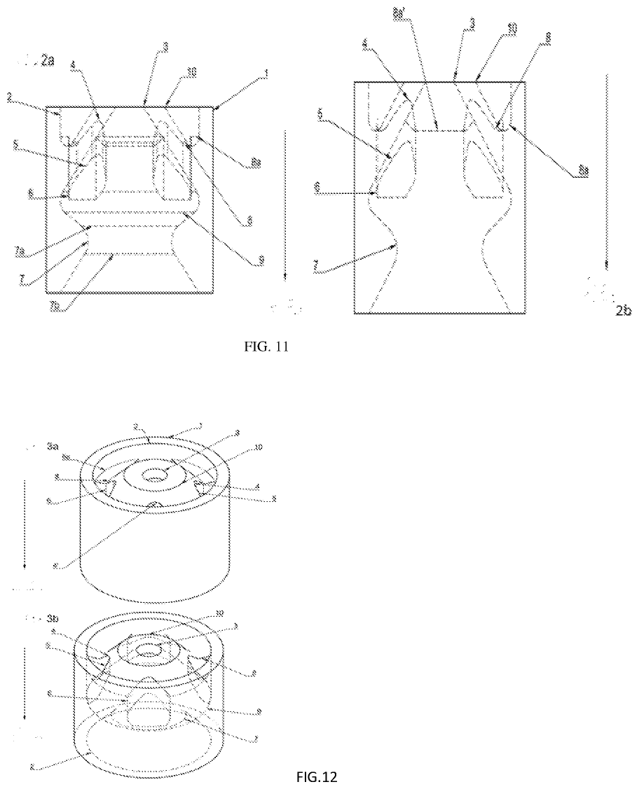

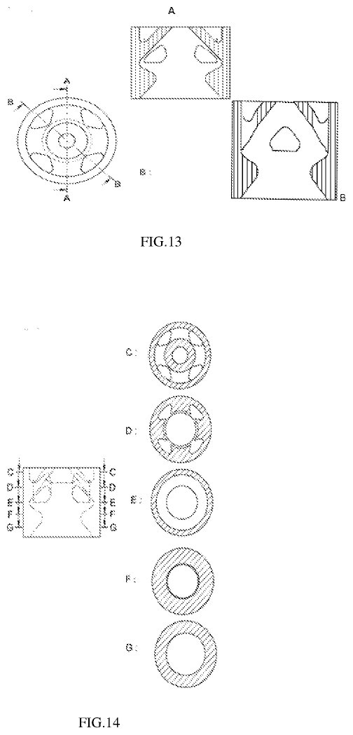

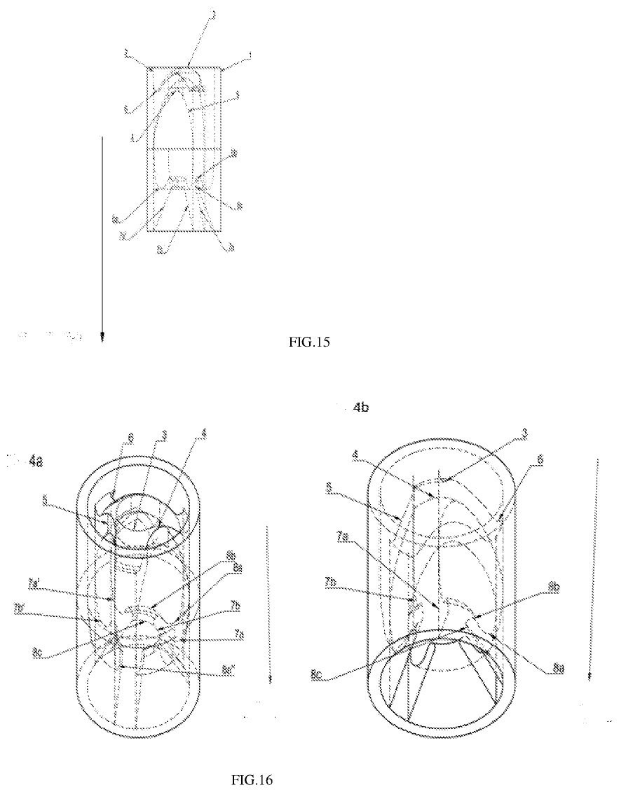

Another aspect of the embodiment of the invention as depicted in FIG. 3 is further described drawing reference to FIG. 12: Here 3a gives Top 3D isometric view of the static mixer. Flow direction is also shown and is along the length of the tube. This view is to better understand the structure of the entry surface and the nature of its changes. From this view, primarily the three-dimensional nature of the upper divergent slope along with the splitting of flow into sections and the plateau can be observed (3a_6,3a_10). 3b View of 3a with hidden edges (internal) represented as dotted lines. Flow direction is also shown and is along the length of the tube. This view is to better visualize the 3D nature of the flow splitting and the internal convergent slope (3b_6,3b_7,3b_9)

One aspect of the embodiment of the invention depicted in FIG. 3 for the first time is illustrated drawing reference to FIG. 13 that gives the Section view showing the vertical cross-section of the static mixer, from vertical split to radial constriction. 2 Sections are made, and they are labelled as follows: Section A: Vertical Section at the mid-plane of the mixing element, showing the radial splitting of flow along the diverging slope in the front view. 5 Section B: Orthographic (45 degree) Section at the mid-plane of the mixing element, showing the radial splitting of flow in between the slots.

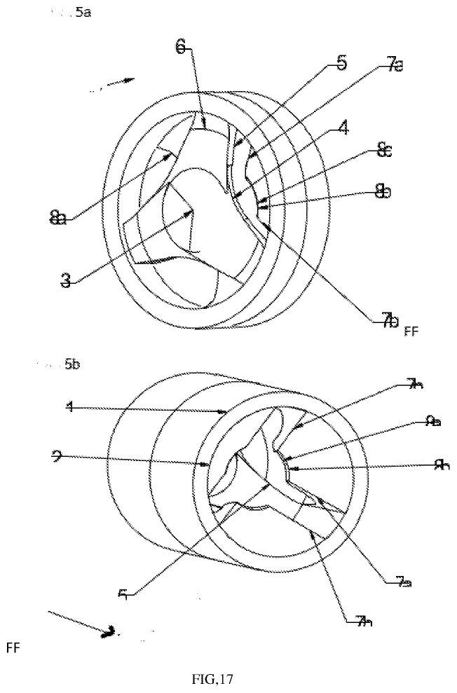

One important aspect of the embodiment of the invention contained in FIG. 3 is further illustrated drawing reference to FIG. 14 which gives the Section view showing the changing cross-section of the static mixer, from radial split to reconverging after the radial converging slope. 5 Sections are made, spread across the length of one mixer element. They are labelled as follows: Section C: Section at the inlet of the mixing element, showing the radial splitting of the cross-section from the top view, and the expansion of the central through hole after the plateau. Section D: Section in the first half of the mixing element, showing a transition from the diverging slope to an open expansion and recombining region post splitting. Section E: Mid-section of the mixer, showing the radial converging slope that forces fluid to the central hole. Section F: Section in the second half of the mixer, showing the converging slope directing fluid toward the central hole. Section G: Final cross-section of the mixing element, showing the gradual ramp, from the central hole to the outer pipe cross-section.

Additional aspects of the embodiment of the invention as depicted in FIG. 3 for the first time can be realized by varying the key aspects of the invention as given here: the entry length and the exit length of the mixer can be varied according to the intended working fluid; the aspect ratio of the initial cross-section to the subsections can be varied, as defined by the relation: The total area of the slots/Area of initial cross-section; the diverging slopes can have n number of splits where n≥2; the central plateau and through hole can be eccentric or non-eccentric with the central axis; the slots on the slope (cross-section splits) can have an angle α, where 180°/n (close clutter)≤α≤360°/n (radially symmetric), and n is the number of splits; the central plateau diameter can range from 0.4*D to 0.75*D, where D is the inner diameter of the pipe; the central through hole can have a diameter of 0.2*d to 0.8*d, where d is the diameter of the plateau; the central plateau and hole can have any cross-sectional shape, with side m≥3, circular, elliptical etc; the converging and diverging slopes can have an angle ranging from 20°≤μ<70° with the longitudinal axis of the pipe. (Defined by the angle between the central and radial extreme circumferences; the slots can be asymmetric and be of different shapes.

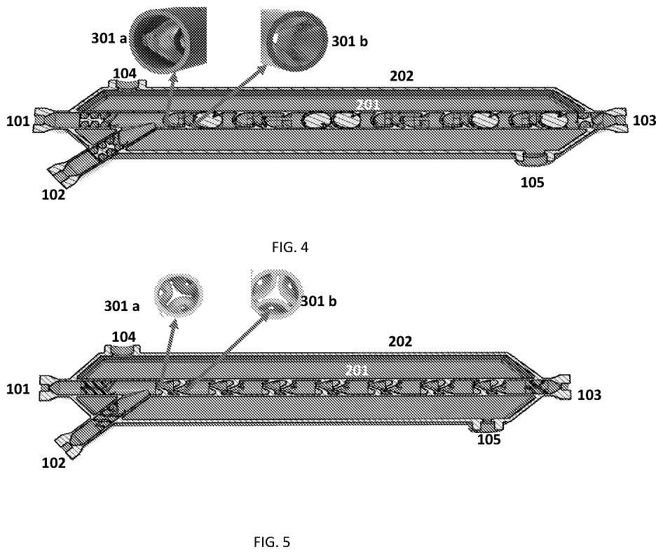

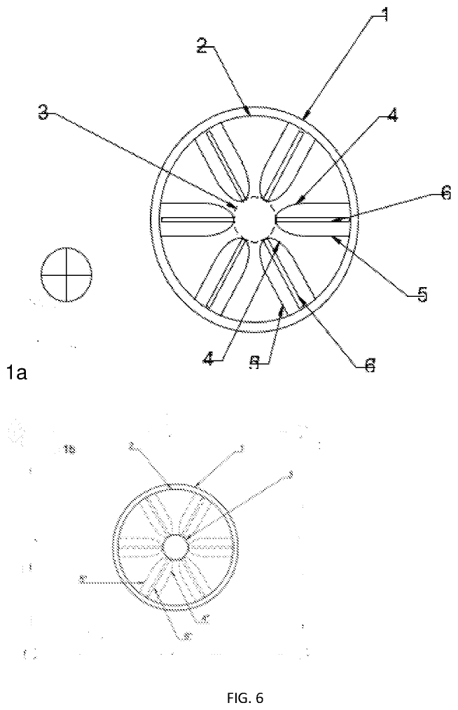

Description of the Embodiment of the Invention as Depicted in FIG. 4 for the First Time with Individual Static-Mixers Possessing an Axisymmetric Hubcap Consisting of 3 Supporting Limbs as the Structural Element

Drawing reference to FIG. 4, the specific embodiment shows the cross-sectional view of the apparatus comprising the stacked static mixers individually possessing an axisymmetric hubcap consisting of 3 supporting limbs as the structural element responsible for splitting and combining the multiphasic flow, wherein the assembly of stacked individual static mixers and their arrangement in a conduit is depicted. Here the splitting action is realized by way of the structural elements in the form of axisymmetric hubcap consisting of 3 supporting limbs on the inner walls of the individual static mixers. The figure also depicts cross sectional view of the conduit having the stacked static mixers showing the alternating splitting and combining zones. The dimensions of the conduit on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 205 mm; Inlet nozzle shape is circular in cross-section. On the utility side, the parameters are: thickness is 2 mm; width is 38 mm; Inlet and outlet nozzle diameter is 10 mm; shape is rectangular; The 3D image of the Splitting and combining pattern for static mixing of fluids is clearly depicted herein. The splitting and combining pattern is repeated throughout the length of the process side. Here 201 represents the Metal Wall of the inside tube containing static mixers and the flow volume for process fluid, whereas 202 is the outer casing of the wall. 301 a & b represent the blow-up images of the flow path through the static mixer possessing axisymmetric hubcap consisting of 3 supporting limbs. The unshaded area indicates the path for fluid flow. The important embodiment of the invention as depicted in FIG. 4 for the first time is further illustrated drawing reference to FIGS. 15 to 19 that describe the specific aspects of the embodiment illustrated in FIG. 4 in a detailed manner in the following paragraphs.

### Description of the Individual Static Mixer Possessing an Axisymmetric Hubcap Consisting of 3 Supporting Limbs as the Structural Element

A monolith static mixer for mixing multiphase flow comprising an axisymmetric hubcap that splits the flow area, wherein the cap consists of 3 supporting limbs that split the flow region into 3 openings/sections and are eccentric to the pipe central axis. From the cap structure, each opening directs fluid into a U-ramp (which reverses flow direction and causes the fluid to collide with incoming streams. The U-ramp is provided with relief slots, that are just below the hubcap supports. These relief slots provide easy exit paths for fluid and prevent excess back pressure. A common central hole connects the relieve slots and provides an exit channel for the working fluid. Multiple Static mixers can be stacked axially to enhance the mixing and dispersion of the multiphase flow elements. Each successive mixer that is stacked can be oriented with the openings and guide vanes at an angular offset, to enhance the mixing. The U-ramp is provided with a smooth, gradual slope, leading to the circular pipe cross-section.

### Description of Flow

The flow regime initially gets split into the openings between the supports when it encounters the hubcap. The circular flow cross-section is split into 3 smaller pockets by the hubcap and then opens into the U-ramp region. Fluid from each of the openings is forced to reverse its direction and interact with incoming fluid in the central cavity. From this region, the working fluid is pushed out through the relief slots and central hole, where further interaction occurs due to the smaller cross-section area of the holes.

Description of Different Aspects Related to the Embodiment as Illustrated in FIG. 4 for the First Time with Each Static-Mixer Possessing an Axisymmetric Hubcap Consisting of 3 Supporting Limbs as the Structural Element Drawing Reference to FIGS. 15-19) Taking Guidance Parameters as Given Hereunder

These labels are common for all further images and represent the specific features of the embodiment as first depicted in FIG. 4 wherein each static mixer is possessing an axisymmetric hubcap consisting of 3 supporting limbs as the structural element and are illustrated in FIGS. 15-19 taking the guidance parameters as given hereunder. (Reference convention: feature labelled as 3 in FIG. 1a is to be referenced as 1a_3) wherein,
1 indicates Outer Diameter of the surrounding pipe of the static mixer, which is cylindrical in nature,
2 indicates Inner Diameter of the surrounding pipe that is cylindrical in nature;
3 indicates Central hubcap;
4 indicates Curved surface between 2 supports;
5 indicates Flat surface of supports/flow section;
6 indicates Curved surface between supports and interior wall of pipe;
7 indicates, 7a is Right surface of the relief slots, 7b: Left surface of the relief slots;
8 indicates 8a is Leading curved surface of U-ramp. 8b is Farthest edge of U-ramp. 8c is Exit edge of U-ramp.

One aspect of the embodiment of the invention as depicted in FIG. 4 for the first time can be illustrated drawing reference to FIG. 15 which gives The Front view of the static mixer. Hidden edges (hubcap split and U-ramp) are depicted as dashed lines. Flow direction is also shown and is along the length of the tube. Individual static mixer elements are stacked in succession to give enhanced mixing effects. This view shows the redirection of flow by the U-ramps. FIG. (15_7a,15_7b,15_8a,15_8b).

Another aspect of the embodiment of the invention as depicted in FIG. 4 for the first time can be illustrated drawing reference to FIG. 16: Here 4a gives Top 3D isometric view of the static mixer. Flow direction is also shown and is along the length of the tube. This view is to better understand the structure of the entry surface and the nature of its changes. From this view, primarily the three-dimensional nature of the hub cap along with the redirecting of flow by the U-ramps can be observed (4a_3,4a_8a). 4b gives Bottom 3D isometric view of the static mixer, with hidden edges (internal), represented as dotted lines. Flow direction is also shown and is along the length of the tube. This view is to better visualize the 3D nature of the slope connecting the pipe section to the U-ramps (4b_7a,4b_7b).

One important aspect of the embodiment of the invention as depicted in FIG. 4 for the first time is further illustrated drawing reference to FIG. 17: Here 5a gives Top-right trimetric view of the static mixer. Flow direction is also shown and is along the length of the tube. This view is to better understand the structure of the entry surface and the nature of its changes. From this view, primarily the three-dimensional nature of the hubcap (5a_3) along with the support limbs are in focus. 5b gives Left bottom trimetric view of the static mixer. Flow direction is also shown and is along the length of the tube. From this view, an improved 3D visualization of the U-ramp and the gradual slope for additive manufacturing along with the relief slots can be observed.

One more aspect of the embodiment of the invention as depicted in FIG. 4 for the first time can be further illustrated drawing reference to FIG. 18 which gives the Section view showing the vertical cross-section of the static mixer, from vertical split to basin collection. 2 Sections are made, and they are labelled as follows: Section A: Horizontal Section at the mid-plane of the mixing element, showing the radial splitting of flow and the 3D visualization of the U-ramp. Section B: Vertical Section at the mid-plane of the mixing element, showing the radial splitting of flow by the hubcap and supports. The relief slots and all the U-ramps can be observed as well.

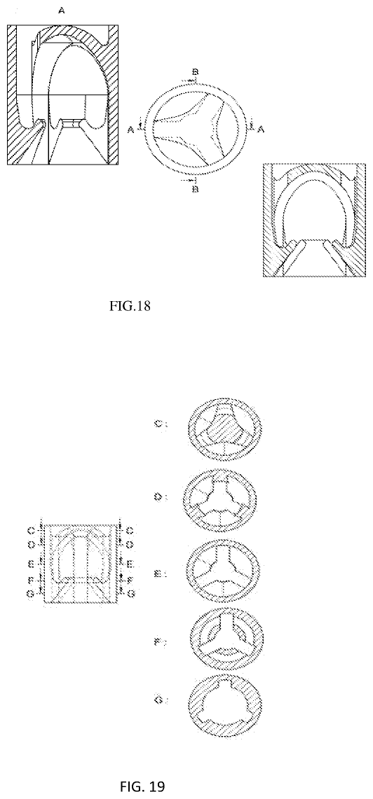

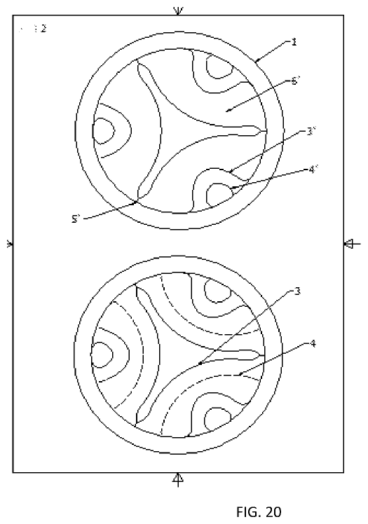

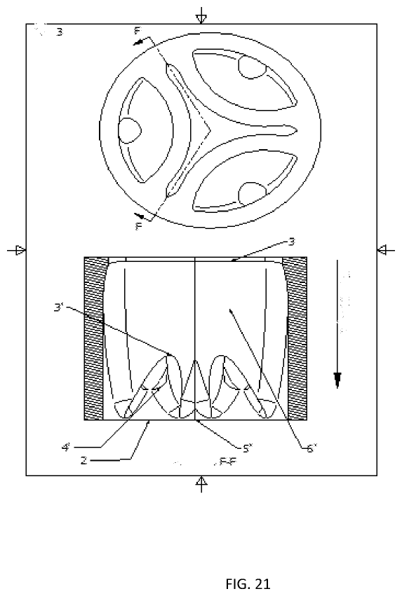

Another aspect of the embodiment of the invention as depicted in FIG. 4 for the first time is described drawing reference to FIG. 19 that gives the Section view showing the changing cross-section of the static mixer, from radial split to mixing and flow through the relief valve and central hole. 5 Sections are made, spread across the length of one mixer element. They are labelled as follows: Section C: Section at the inlet of the mixing element, showing the radial splitting of flow by the hub cap from the top view. Section D: Section in the first half of the mixing element, showing a transition from the hubcap and support limbs to an open expansion and recombining region post splitting. Section E: Mid-section of the mixer, showing the U-ramp and relief slots with the central hole. Section F: Section in the second half of the mixer, showing U shaped nature of the U-ramp that redirects flow. Section G: Final cross-section of the mixing element, showing the central drain and relief slots through which, all fluid must pass.

Additionally 5 embodiments can be realized by the variation of the key aspects of the embodiment as first depicted in FIG. 4 as given here: The entry length and the exit length of the mixer can be varied according to the intended working fluid; The aspect ratio of the initial cross-section to the subsections can be varied, as defined by the relation: Total area of the split in the hubcap/Area of initial cross-section; The hub cap can have n number of splits where n≥2; The hubcap centre and central drain can be eccentric or non-eccentric with the central axis; The relief slots and supporting limbs can have an angle α, where 180°/n (close clutter)≤α≤360°/n (radially symmetric), and n is the number of limbs; The supporting limbs can have a tapered edge or a straight one; The supporting limbs can have an angle β with the longitudinal axis, where 20≤β≤70; The U-ramp can have a height h, where 0.1*H≤h≤0.6*H, where H is the total length of the static mixer; The U-ramp can have a trailing edge slope of angle α with longitudinal axis, with 20≤α≤90.

### Description of the Embodiment as Depicted in FIG. 5 for the First Time Wherein the Structural Element is a 3 Arch Like Structures Arranged Around the Axis of the Pipe

Drawing reference to FIG. 5, the specific embodiment shows the cross-sectional view of the apparatus comprising the stacked static mixers possessing 3 arch like structures arranged around the axis of the pipe as the structural elements responsible for splitting and combining the multiphasic flow in the conduit, wherein the assembly of stacked individual mixers and their arrangement in a conduit is depicted. Here the splitting action is realized by way of the 3 arch like structures arranged around the axis of the pipe on the inner walls of individual static mixers that have been stacked in the conduit and FIG. 5 further depicts the alternating splitting and combining zones in the conduit. The dimensions of the conduit on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 205 mm; Inlet nozzle shape is circular in cross-section. On the utility side, the parameters are: thickness is 2 mm; width is 38 mm; Inlet and outlet nozzle diameter is 10 mm; shape is rectangular; The 3D image of the Splitting and combining pattern for static mixing of fluids is clearly depicted herein. The splitting and combining pattern is repeated throughout the length of the process side. Here 201 represents the Metal Wall of the inside tube containing static mixers and the flow volume for process fluid, whereas 202 is the outer casing of the wall. 301 a & b represent the blow-up images of the flow path through the static mixers possessing 3 arch like structures arranged around the axis of the pipe internally. The unshaded area indicates the path for fluid flow. The specific embodiment as illustrated in FIG. 5 for the first time is further illustrated drawing reference to FIGS. 20-22 that described the specific aspects of the embodiment as depicted in FIG. 5 in a detailed manner in the following paragraphs.

### Description of the Static Mixer Possessing the Structural Element Having 3 Arch Like Structures Arranged Around the Axis of the Pipe Internally

Each individual Static mixer forming a part of the stacked plurality of static mixers in the conduit for passive mixing of the multiphase flow possesses the structural element consisting of 3 Nozzle like components arranged around the axis of the pipe internally. The mixer element consists of 3 arch like structures that split the flow and then proceed to reduce down to smaller arch like structures. The reduction of the cross-section areas of the arches causes the flow to be squeezed and jet out the exit of the mixer (FIG. 21). Multiple static mixers can be stacked axially with a slight rotation along the axis of the pipe to promote mixing.

### Description of Flow

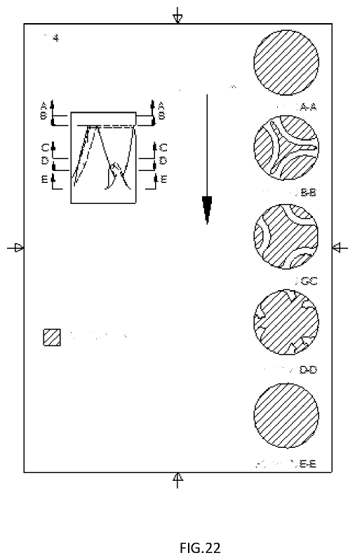

Description of the flow is explained with the help of FIG. 22. The flow starts off with a circular cross section as show in Section A-A. The flow then encounters the static mixers and is split into 4 distinct flows as seen in Section B-B. The inner flow expands due to the expanding cross-sectional area whilst simultaneously the outer peripheral flow gets contracted. (Section C-C) The difference in the flow velocities between the inner and outer streams promotes mixing and also aids heat transfer between the outer fluid streams and the walls of the pipe. The increase in heat transfer is due to the increased velocity of the outer fluid streams. The fluid streams recombine into a single stream; there might be formation of vortices at this recombination junction. (Section D-D).

Description of Specific Aspects of the Embodiment of the Invention with 3 Arch Like Structures Arranged Around the Axis of the Pipe as Depicted in FIG. 5 for the First Time Drawing Reference to FIGS. (20-22) Taking Guidance Parameters as Given Hereunder.

The flow of fluid happens in the axial direction of the pipe. Dashed lines represent hidden edges that might not be visible in the view. The specific aspects of the embodiment of the invention with 3 arch like structures arranged around the axis of the pipe as depicted for the first time in FIG. 5 drawing reference to FIGS. 20-22) taking guidance parameters as given hereunder. The labelled entities against the numbers indicated guide to understand the specific aspects of the embodiment as depicted in FIG. 5 for the first time and further illustrated in FIGS. 20-22 wherein,
1 indicates Outer Diameter (OD) of the pipe which is circular in nature;
2 indicates Inner Diameter (ID) of the pipe;
3 indicates Outer edge of the beginning of the cusp structure; 3′ Outer edge of the end of the cusp structure It is arch shaped;
4 indicates Inner edge of the beginning of the cusp structure; 4′ Inner edge of the end of the cusp structure;
5 indicates Intersection of Outer edge of cusp structure with ID at entry; 5′ Intersection of Outer edge of cusp structure with ID at exit;
6 indicates Inner Surface of the cusp structure; 6′ Outer Surface of the cusp structure.

The important aspect of the embodiment of the invention as depicted first time in FIG. 5 is further illustrated drawing reference to FIG. 20: Here 2 shows the exit region of the static mixer. All four streams of fluid mix at this cross-section to form a circular flow cross-section. The radially inwards surface (2_6) can be observed. This surface bridges the edges 3 and 3′. The helps the middle fluid stream to expand while the remaining fluid streams are being squeezed.

One aspect of the embodiment of the invention as depicted first time in FIG. 5 is further illustrated drawing reference to FIG. 21: Here 3 shows a cut section of the static mixer with one of the three cusp structures removed. The thick dashed angled line labelled F-F is the cutting line. The cut section of the static mixer can be observed in the bottom figure. Here we can observe the shape of edge 3′.

One more aspect of the embodiment of the invention as depicted first time in FIG. 5 is further illustrated drawing reference to FIG. 22: Here 4 shows the transformation of the fluid cross-section as it transverses the static mixer. The figure on the left is the 3D shape of the fluid domain. This extracted domain is cut using thick lines which terminate with arrows; they are labelled A, B, C, D, and E. The shaded region depicts the fluid region. The fluid cross-sections are explained here: Section A-A: This section represents the undisturbed fluid flow through an empty pipe before it encounters the static mixer. Section B-B: This section represents the entry/start of the static mixer. The flow gets split into 4 distinct regions: One inner flow regime and three radially symmetric flow regimes. Section C-C: This section represents the fluid after it has traversed halfway through the static mixer. It can be observed here that the middle fluid streams cross-sectional area has increased whilst the cross-sectional area of the outer fluid streams has decreased. This change in the cross sections causes the fluid to attain different velocities. The inner fluid stream has a slower velocity. The outer fluid streams have a higher velocity. The higher fluid velocity of the outer streams increases its heat transfer with the ID of the pipe. Section D-D: This section shows the cross-section of the fluid before it fully exits the static mixer and at the upper arch of edge 3′. This is the region where the mixing between the different fluid streams starts to take place. The different fluid velocities can cause the formation of vortices whose axis of rotation is a line tangent to the ID of the pipe. In a multiphase flow, if only gaseous phase enters any one of the outer streams it will attain a higher velocity and disperse into the slower velocity fluid in the middle. Section E-E: This section shows the cross-section of the fluid flow after it fully exits the static mixer. All the streams have combined into a singular circular cross-sectional stream.

Additional embodiments in respect of the embodiment depicted first time in FIG. 5 are also possible wherein the length of each Cusp structure can be unique; The edges 3′ and 4′ can be rotated by an angle θ about the axis of the pipe with respect to edges 3 and 4 respectively, where 0≤θ≤180; The surfaces 6 and 6′ can be perforated; The edges 3, 4, 3′, and 4′ can be made of an arch of n sided polygon where n≥3; There can be x number of cusp structures, where x≥2; The fluid can be sent in either axial directions where n≥3; There can be x number of cusp structures, where x≥2; The fluid can be sent in either axial directions where n≥3; There can be x number of cusp structures, where x≥2; The fluid can be sent in either of the axial directions.

Accordingly, the apparatus and the method disclosed herein represent a significant improvement over prior art by providing a method and apparatus that uniquely solve the problems of providing a superior mixing action in a multi-phasic flow ensuring enhanced mass-transfer, heat transfer and improved mixing and dispersion of gas-liquid systems with minimal pressure head loss downstream of the injection site.

Those skilled in the art will appreciate that the conception, upon which this disclosure is based, may readily be utilized as a basis for designing other products without departing from the spirit and scope of the invention as defined by the appended claims. Therefore, the claims are not to be limited to the specific examples depicted herein. For example, the features of one example disclosed above can be used with the features of another example.

Furthermore, various modifications and rearrangements of the parts may be made without departing from the spirit and scope of the underlying inventive concept. For example, the geometric configurations disclosed herein may be altered depending upon the application, as may be the material selection for the components. Thus, the details of these components as set forth in the above-described examples, should not limit the scope of the claims.

The various embodiments of the invention of “Method and apparatus for passive mixing of Multiphase flow” are realized in the following examples.

The apparatus for enhancing the mixing efficiency of a multiphasic flow comprising a stacked plurality of static mixers that possessed specially configured structural elements to effect alternate splitting and combining of the multiphasic flow by way of the structural elements of axisymmetric cap with six-limbs, axisymmetric divergent slope with a four-limbed cap, axisymmetric hubcap consisting of 3 supporting limbs and with 3 arch like structures arranged around the axis of the pipe, on the inner walls of the individual static mixer that formed the stack of the plurality of static mixers in the conduit of the apparatus as described in the invention are produced as per the detailed description as disclosed by the instant invention and are tested to evaluate their mixing efficiency experimentally taking water-acetic acid-toluene system and the results are compared with those obtained from experiments conducted on similar lines in batch mode as well as in a tube reactor. The experimental results are given in the following paragraphs.

Mass transfer studies are conducted by the “Method and Apparatus for passive mixing of multiphase flow” or Static mixer reactors (SMRs) as disclosed by the invention to assess and quantify the mixing capabilities of the apparatus or the reactors. Liquid-liquid extraction (LLE) is the physical method employed to ascertain the effective interphase mass transfer in a given system (reactor or mixed vessel or SMRs).

The liquid-liquid extraction of the ternary system of water-acetic acid-toluene, is studied in a batch system to obtain equilibrium concentration. The same extraction is performed using the apparatus contained in the instant invention to establish their mass transfer efficiency. Similar experiments were conducted in an empty tubular reactor (without the static mixers as disclosed by the instant invention) with a T-joint, to establish the base line mass transfer coefficients without the static mixers. Mass transfer coefficients are evaluated for the liquid-liquid-extraction of water-acetic acid-toluene in a flow system using the apparatus comprising the stacked static mixers with modified geometry as disclosed in the invention. The enhanced efficiency due to the stacked plurality of the static mixers possessing structural elements on their inner walls present inside the apparatus as contained in the instant invention is evaluated by comparing the experimental results.

### Example 1

### Batch Experiment to Establish the Equilibrium Between Toluene and Water Phase for Acetic Acid (AA) Partition

Equal volumes (50 ml) of 30 w/w % Acetic Acid in water (feed, raffinate) and Toluene (extractant) are taken in a Round bottom flask. The mixture is kept for stirring at 950 rpm. Samples are collected for every fifteen minutes, and the mixture is transferred to separating funnel where the ternary system gets separated into two definite layers namely, top organic layer which is toluene dominant and the bottom aqueous layer that is water dominant. Acetic acid content in both the layers is analysed by titrating known amount of sample against 1N NaOH. 15 ml of methanol and water are used as solvents for titrating the organic and aqueous layers respectively. The amount of NaOH consumed is used to determine Acetic acid % in both the layers by using equation 1

$$wt / wt \% Acetic Acid = \frac{{N}_{N a O H} \times Vol of NaOH consumed \times Molecular Weight of Acetic Acid}{10 \times Weight of sample taken} \qquad eqn . 1$$

Burette reading gives the value for the Vol of NaOH consumed in ml. Samples are collected until repetitive burette readings occur. Content of acetic acid taken as normality is used to calculate Partition coefficient (K_{D}) and Mass transfer coefficient (K_{L}α) which is given by equation 2 and 3 respectively.

$${K}_{D} = \frac{[ A {A}_{org} ]}{[ A {A}_{a q} ]} \qquad eqn . 2$$

Where, [AA_{org}] is the concentration of acetic acid in organic phase and [AAag] implies concentration of acetic acid in aqueous phase. Using the equilibrium concentration and the initial concentration of the solute AA in both the phases the mass transfer coefficient for an interphase mass transfer is calculated according to the equation 3. This will be used in subsequent sections for SMRs.

$${K}_{L} a = \frac{1}{τ} ln ( \frac{{C}_{i n} - {C}^{*}}{{C}_{out} - {C}^{*}} ) {min}^{- 1} \qquad eqn . 3$$

Where Cᵢₙ, Cₒᵤₜ are the concentrations of the solute in inlet, outlet of the reactor at time τ and C* is the equilibrium concentration. The data obtained from batch studies is summarised in table1. From table1, it can be observed that between 75 to 150 min, the concentration of AA in organic phase remained constant which indicated the attainment of the equilibrium between the two layers. The average concentration of AA in Organic (toluene) phase is taken as the equilibrium concentration and it is found to be 0.634N. This is used as C* in the equation 3 to calculate mass transfer coefficient for all the subsequent calculations for the apparatus comprising static mixer reactors (SMRs).

TABLE 1
Batch study data
Concentration of AA in toluene layer as function
of time of contact in a batch system

| | | [AA], |
|---|---|---|
| Time | wt % AA | Normality |
| 0 | 0.000 | 0.000 |
| 15 | 2.227 | 0.371 |
| 30 | 1.565 | 0.391 |
| 45 | 3.056 | 0.509 |
| 60 | 3.571 | 0.595 |
| 75 | 3.881 | 0.646 |
| 90 | 3.750 | 0.625 |
| 105 | 3.870 | 0.644 |
| 120 | 3.853 | 0.642 |
| 135 | 3.781 | 0.630 |
| 150 | 3.709 | 0.618 |

| | |
|---|---|
| Equilibrium | 0.634N |
| concentration of AA in | |
| Toluene organic layer | |

### Example 2

Studies Conducted with the Apparatus Containing Stacked Plurality of Static-Mixers Possessing Structural Elements of Axisymmetric Hubcap Consisting of 3 Supporting Limbs, 3 Arch Like Structures Arranged Around the Axis of the Pipe, Axisymmetric Cap with Six Limbs, Axisymmetric Divergent Slope with a Four-Limbed Cap (Static Mixer Reactors (SMRS) in a Housing and a Tube Reactor with T-Joint

### Experimental Setup

Liquid-liquid extraction procedure was carried out in SMRs to determine mass transfer coefficient by physical method. Two pumps, a separating funnel, and the SMR constituted the experimental setup. Calibrated metering pumps were used to pump known and desired flow of both the solvent and the feed solution. They enter the SMR, get mixed due to the static mixers (SMs) in the reactor and exchange takes place between immiscible organic and aqueous phases. The outlet of the SMR is connected to a separating funnel, where both phases collect and separate immediately, thereby stopping further exchange of mass between the phases. Each sample that was taken was immediately separated, and the solute content of both the layers was determined. This experiment was carried out at six different residence times: 0.25, 0.5, 1, 1.5, 2, 2.5 minutes, by varying the flow rates of the two liquids. The ratio of flow rates of both phases was maintained constant at all time intervals.

### Experimental Procedure

The feed solution (30% Acetic Acid in water) and solvent (Toluene) are pumped into the SMRs. Here they flow concurrently getting intimately mixed due the presence of the novel SMs and resulting in the mass transfer of acetic acid between the two phases. The flowrates of the pumps are fixed according to residence time, which is given by equation 4.

$$Flowrate = \frac{V olume of reactor}{Res i dence time} \frac{mL}{min} \qquad eqn . 4$$

The collected mixture is left for separation into aqueous and organic layers. Both the layers are analysed for Acetic Acid content by taking 5 gm of sample and titrating it against 1N NaOH as discussed above. Equilibrium concentration is found by conducting batch studies. Mass transfer coefficient is calculated at each time of residence (τ) using equation 3.

The experimental results and the mass transfer coefficients obtained, for the empty tube reactor, SMRs possessing axisymmetric hubcap consisting of 3 supporting limbs, 3 arch like structures arranged around the axis of the pipe, axisymmetric cap with six limbs, axisymmetric divergent slope with a four-limbed cap as the structural elements are given below in tables 2, 3, 4, 5 & 6 respectively.

TABLE 2
Estimation of mass transfer coefficients for empty tube with a T-Joint (baseline “flow” reactor)

| | organic layer | | | | | aqueous layer | | | | | | |
|---|---|---|---|---|---|---|---|---|---|---|---|---|
| | | 1.0N | | | | | 1.0N | | | | | |
| | | NaOH | | | | | NaOH | | | | | Mass |
| Residence | wt of | titre | | wt % | | wt of | titre | | | Concetration | | transfer |
| time | sample | value, | Calculated | AA | Concetration | sample | value, | Calculated | % AA | [AA aq] | Partition | coefficient |
| (min) | (gm) | ml | wt % AA | avg | [AA org] (N) | (gm) | ml | wt % AA | avg | (N) | coefficient | min \hat{ }(−1) |
| 0.25 | 5.03 | 1.5 | 1.84 | 1.79 | 0.30 | 5 | 22.5 | 27.8 | 27.84 | 4.636 | 0.064 | 2.501 |
| | 5.01 | 1.4 | 1.73 | | | 5.02 | 22.6 | 27.8 | | | | |
| 0.5 | 5.05 | 1.7 | 2.08 | 2.03 | 0.34 | 5.03 | 22.3 | 27.4 | 27.57 | 4.590 | 0.074 | 1.501 |
| | 5.01 | 1.6 | 1.98 | | | 5 | 22.4 | 27.7 | | | | |
| 1 | 5.05 | 1.9 | 2.33 | 2.27 | 0.38 | 5.03 | 22 | 27.1 | 27.17 | 4.524 | 0.084 | 0.896 |
| | 5.01 | 1.8 | 2.22 | | | 5.01 | 22.1 | 27.3 | | | | |
| 1.5 | 5.02 | 1.9 | 2.34 | 2.40 | 0.40 | 5 | 21.9 | 27.1 | 27.04 | 4.504 | 0.089 | 0.653 |
| | 5.03 | 2 | 2.46 | | | 5.04 | 22 | 27.0 | | | | |
| 2 | 5.01 | 2.1 | 2.59 | 2.59 | 0.43 | 5.02 | 21.8 | 26.9 | 26.91 | 4.482 | 0.096 | 0.561 |
| | 5.01 | 2.1 | 2.59 | | | 5 | 21.8 | 27.0 | | | | |
| 2.5 | 5.06 | 2.2 | 2.69 | 2.64 | 0.44 | 5.02 | 21.7 | 26.7 | 26.74 | 4.454 | 0.099 | 0.464 |
| | 5.02 | 2.1 | 2.59 | | | 5.04 | 21.8 | 26.8 | | | | |

The first column is the residence time set for the articular run. This is for combined flow rates of the liquids and the tube volume is 40 ml. The next 5 columns show the estimation of the concentration of AA in organic layer estimated by titrating the isolated layer with 1N NaOH. Subsequent 5 columns under the Aqueous layer indicate the same estimation for aqueous layer. The column partition coefficient is derived from the equation 2 and the mass transfer concentration is estimated based on equation 3. Equilibrium concentration of AA in organic layer is 0.64N estimated earlier from the batch extraction experiments.

It is to be noted that for a fixed volume of reactor (here a tube), higher the residence time means lower the flow rates. Lower flow rate means less velocity of the liquids through the reactor. It is established in the science that higher the flow rate, better is the mixing and hence the mass transfer coefficient (m.t.c). The trend of m.t.c with residence time seen in the first and last columns of the above table indicate the same trend. Higher residence time, lower the flow rates, slower the velocity therefore lower the mass transfer coefficient. The trend asymptotically reaches a limit, which can be seen from the above data.

Tables 3, 4, 5, 6 summarise the data obtained from experiments conducted in SMRs wherein the individual static mixers are possessing the structural elements of axisymmetric hubcap consisting of 3 supporting limbs, 3 arch like structures arranged around the axis of the pipe, axisymmetric cap with six limbs, axisymmetric divergent slope with a four-limbed cap.

TABLE 3
Experimentally Estimated mass transfer coefficient for different
residence times for SMR possessing the structural element
of axisymmetric hubcap consisting of 3 supporting limbs.

| Time, | m.t.c |
|---|---|
| min | (min (−1)) |
| 0.25 | 4.00 |
| 0.5 | 2.11 |
| 1 | 1.09 |
| 1.5 | 0.88 |
| 2 | 0.65 |
| 2.5 | 0.55 |

TABLE 4
Experimentally Estimated mass transfer coefficient
for different residence times for SMR possessing
structural element of 3 ARCH LIKE STRUCTURES
ARRANGED AROUND THE AXIS OF THE PIPE

| Time, | m.t.c |
|---|---|
| min | (min (−1)) |
| 0.25 | 3.35 |
| 0.5 | 2.00 |
| 1 | 1.04 |
| 1.5 | 0.79 |
| 2 | 0.60 |
| 2.5 | 0.50 |

TABLE 5
Experimentally Estimated mass transfer coefficient for
different residence times for SMR possessing the structural
element of axisymmetric cap with six limbs

| Time, | m.t.c |
|---|---|
| min | (min (−1)) |
| 0.25 | 3.35 |
| 0.5 | 2.10 |
| 1 | 1.09 |
| 1.5 | 0.79 |
| 2 | 0.66 |
| 2.5 | 0.52 |

TABLE 6
Experimentally Estimated mass transfer coefficient for different
residence times for SMR possessing the structural element
of axisymmetric divergent slope with a four-limbed cap.

| Time, | m.t.c |
|---|---|
| min | (min (−1)) |
| 0.25 | 4.38 |
| 0.5 | 2.38 |
| 1 | 1.30 |
| 1.5 | 0.95 |
| 2 | 0.79 |
| 2.5 | 0.70 |

From tables 3, 4, 5 & 6 it can be concluded that continuous systems with novel split and combine SMRs show higher mass transfer coefficient compared to empty Tubular reactor due to the presence of static mixers possessing structural elements that could enhance the mixing efficiency and in turn mass transfer between the different phases of a multiphasic system. This establishes the utility of the apparatus and method disclosed in the invention for interphase mass transfer devices.

### Advantages of the Invention

The Method and apparatus as disclosed by the instant invention for enhancing mixing efficiency of multi-phasic passive flow herein has the following advantages,
1. A significant improvement over prior art by providing an apparatus comprising a stacked plurality of static mixers that uniquely solves the problems of providing a superior mixing action in a multi-phasic flow.
2. The apparatus disclosed herein ensures enhanced mass-transfer, heat-transfer and improved mixing and dispersion of gas-liquid systems with minimal pressure head loss downstream of the injection site.
3. The apparatus disclosed herein operates by splitting and combining the multiphasic flow due to the presence of limbed structural elements present on the inner walls of the individual static mixers that can be stacked in a conduit axially offering a thorough mixing in multi-phasic systems and can be employed in additive manufacturing; process industries, as is exemplified from the experimental results obtained in the liquid-liquid-extraction studies done with water-acetic acid-toluene system wherein the invention provided better mass-transfer coefficient compared to the same done in a static mixer devoid of such geometrical modifications.
4. One important embodiment of the invention stresses on the importance of the limbed structural elements that could split the multiphasic flow into various streams and allowing them to get combined thereby ensuring a thorough mixing of the elements of the multiphasic flow which is very essential to obtain products with high purity and in higher amounts especially when there is a considerable difference in the densities of the individual phases of the multiphasic system.
5. The heat transfer and the mass transfer between the liquid and gaseous phases of the multiphasic fluid is enhanced due to the thorough mixing ensured by the limbed structural elements present in the individual static mixers and this aspect of the invention makes the invention suitable for application in pharmaceutical industries.

### Analysis of Novelty, Inventiveness and Utility

The instant invention of “METHOD AND APPARATUS FOR PASSIVE MIXING OF MULTI-PHASE FLOW” is novel in the light of the prior art as it provides an apparatus or reactor comprising a stacked plurality of static mixers possessing structural elements or mixing elements on their inner walls, that considerably enhanced the mixing of a multiphasic-flow as is evident from the mass-transfer coefficients obtained from the liquid-liquid extraction studies done using water-acetic acid-toluene system. The inventiveness of the instant invention lies in arriving at the apparatus and a method to enhance the mixing efficiency in multi-phasic flow systems by way of introducing an axisymmetric hubcap consisting of 3 supporting limbs, 3 arch like structures arranged around the axis of the pipe, axisymmetric cap with six limbs, axisymmetric divergent slope with a four-limbed cap as structural elements on the inner walls of the individual static mixers that can be stacked in a conduit, which can be employed successfully in processes to obtain better yields. The various structural elements of the static mixers as illustrated in the various embodiments of the instant invention are indicative of the inventiveness of the instant invention. The utility aspect of the instant invention is realized as the instant invention discloses an apparatus that can provide enhanced mixing efficiency in multi-phase flows and which can be successfully employed in chemical process industries for speciality chemicals, pharmaceutical intermediates and API production, polymer production wherein a thorough mixing of the different phases has a profound effect on the yield and purity of the final product.

What is claimed:

1. A method and an apparatus for the passive mixing of a multi-phase(ic) flow or hydrodynamic performance comprising a housing, having a conduit/tube or a channel extending internally from the fluid inlet to the outlet ports that comprises of stacked plurality of static-mixers possessing structural elements or mixing elements on the inner walls of the individual static mixers, that are responsible for splitting the multiphasic flow in to a number of streams and forcible recombination of the streams of the multiphasic flow through the conduit, bringing about the splitting-combining effect on the flow wherein, a) the structural elements or mixing elements are selected from a group comprising of axisymmetric cap with six limbs, axisymmetric divergent slope with a four-limbed cap, axisymmetric hubcap consisting of 3 supporting limbs, 3 arch like structures arranged around the axis of the pipe, which are present on the inner walls of individual static mixers and are responsible for splitting and combining of the flow, resulting in an enhanced mixing of the multi-phasic flow,
b) The conduit comprises of a stacked plurality of, static-mixers possessing structural elements, across the length of the conduit that can allow the fluid to pass through them continuously experiencing splitting and combining, resulting in enhanced mixing, mass-transfer, and heat transfer,
c) The stacking of the individual static-mixers is responsible for forced recombination of the split streams of multiphasic flow at regular intervals,
d) The multiphasic flow experiences a cumulative splitting—combining effect resulting in an enhanced overall mixing efficiency due to plurality of static-mixers that are placed axially along the length of the conduit,
e) The method of enhancing the mixing is by splitting the multiphasic flow into a number of streams and forcible recombination of the streams of the multiphasic flow through the conduit.

2. The apparatus as claimed in claim 1 comprising of stacked plurality of static mixers wherein each individual static mixer of the stack is possessing axisymmetric six limbed cap as the structural element or mixing element wherein,
a) The 6 limbs are supporting limbs that split the flow region into 6 openings/sections, and are eccentric to the pipe central axis,
b) Each opening from the cap structure directs fluid into a collecting basin that has guide vanes to split the flow further,
c) The guide vanes are positioned such that fluid from adjacent openings is forced to mix after splitting,
d) All the basins drain into a common central hole, that serves as a junction point for fluid from multiple channels to mix and flow out,
e) The basin drain is provided with a smooth, gradual ramp, leading to the circular pipe cross-section.

3. The enhanced mixing as claimed in claim 1 when the apparatus comprises of stacked plurality of static mixers possessing axisymmetric cap with six limbs as the structural element can be further enhanced by varying,
a) entry length and the exit length of the mixer according to the intended working fluid,
b) The aspect ratio of the initial cross-section to the subsections in terms of Total area of the split in the upper cap/Area of initial cross-section,
c) number of splits ‘n’ of the upper cap where n≥2,
d) position of the cap centre and collecting drain from eccentric or non-eccentric with the central axis,
e) The cap openings' angle ‘α’, where 180°/n (close clutter)≤α≤360°/n (radially symmetric), and n is the number of splits,
f) edge of the mid-vanes to a tapered edge or a flat edge,
g) Mid-vane length between 0.2*r to 0.9*r, where r is the inner radius of the pipe,
h) The central drain cross-sectional shape with side m≥3, circular, elliptical,
i) angle of descent of the upper cap and basin ranging from 20°≤μ<70° with the longitudinal axis of the pipe wherein the angle of descent is the angle between the central and radial extreme circumferences.

4. The apparatus as claimed in claim 1 comprising of stacked plurality of static-mixers wherein each individual static mixer of the stack is possessing axisymmetric divergent slope with a four-limbed cap as the structural element wherein,
a) The cap comprises of 4 limbs, that split the flow region into 4 openings/sections and are eccentric to the pipe central axis,
b) there is a central plateau that helps force fluid radially, with a through hole in the centre that provides an alternate route for fluid,
c) From the convergent sloped roof, there exists an inner radial slope, that forces fluid to converge to the centre from the edges and all fluid is forced through a small central hole,
d) The radial slope is provided with a smooth, gradual ramp, leading to the circular pipe cross-section.

5. The enhanced mixing as claimed in claim 1 when the apparatus comprises of stacked plurality of static-mixers possessing axisymmetric divergent slope with a four-limbed cap as the structural element can be further enhanced by varying,
a) the entry length and the exit length of the mixer according to the intended working fluid,
b) the aspect ratio of the initial cross-section to the subsections which is given by The total area of the slots/Area of initial cross-section,
c) number of splits ‘n’ of the diverging slopes where n≥2,
d) position of the central plateau and through hole from eccentric or non-eccentric with the central axis,
e) angle α of the slots on the slope (cross-section splits) where 180°/n (close clutter)≤α≤360°/n (radially symmetric), and n is the number of splits,
f) the central plateau diameter from 0.4*D to 0.75*D, where D is the inner diameter of the pipe,
g) the central through hole diameter from 0.2*d to 0.8*d, where d is the diameter of the plateau,
h) cross-sectional shape of the central plateau and hole to side m≥3, circular, elliptical,
i) angle of the converging and diverging slopes ranging from 20°≤μ<70° with the longitudinal axis of the pipe, wherein μ is the angle between the central and radial extreme circumference,
h) the shape of the slots and arrangement to asymmetric.

6. The apparatus as claimed in claim 1 comprising of stacked plurality of static mixers wherein each individual static mixer of the stack is possessing axisymmetric hubcap consisting of 3 supporting limbs as the structural element or mixing element wherein,
a) the cap consists of 3 supporting limbs that split the flow region into 3 openings/sections and are eccentric to the pipe central axis,
b) from the cap structure, each opening directs fluid into a U-ramp which reverses flow direction and causes the fluid to collide with incoming streams,
c) the U-ramp is provided with relief slots, that are just below the hubcap supports, and these relief slots provide easy exit paths for fluid and prevent excess back pressure,
d) a common central hole connects the relieve slots and provides an exit channel for the working fluid,
e) the U-ramp is provided with a smooth, gradual slope, leading to the circular pipe cross-section.

7. The enhanced mixing as claimed in claim 1 when the apparatus comprises of stacked plurality of static-mixers possessing axisymmetric hubcap consisting of 3 supporting limbs as the structural element can be further enhanced by varying,
a) The entry length and the exit length of the mixer according to the intended working fluid,
b) The aspect ratio of the initial cross-section to the subsections as given by, Total area of the split in the hubcap/Area of initial cross-section,
c) number of splits ‘n’ of the hub cap where n≥2,
d) position of the hubcap centre and central drain from eccentric to non-eccentric with the central axis,
e) angle α between the relief slots and supporting limbs, where 180°/n (close clutter)≤α≤360°/n (radially symmetric), and n is the number of limbs,
f) edge of the supporting limbs from a tapered edge to a straight one,
g) angle β of the supporting limbs with the longitudinal axis, where 20≤β≤70,
h) height h of the U-ramp where 0.1*H≤h≤0.6*H, where H is the total length of the static mixer,
i) trailing edge slope angle α of the U-ramp with the longitudinal axis, with 20≤α≤90.

8. The apparatus as claimed in claim 1 comprising of stacked plurality of static mixers wherein each individual static mixer of the stack is possessing 3 arch like structures arranged around the axis of the pipe as the structural element or mixing element wherein,
a) 3 Nozzle like components are arranged around the axis of the pipe internally,
b) The mixer consists of 3 arch like structures that split the flow and then proceed to taper down to smaller arch like structures,
c) The reduction of the cross-section areas of the arches causes the flow to be squeezed and jet out the exit of the mixer.

9. The enhanced mixing as claimed in claim 1 when the apparatus comprises of stacked plurality of static mixers possessing 3 arch like structures arranged around the axis of the pipe as the structural element can be further enhanced by varying,
a) the length of each Cusp structure,
b) The angle of rotation θ about the axis of the pipe of the edges 3 and 4 edges to 3′ and 4′ respectively where 0≤θ≤180,
c) The surfaces 6 and 6′ to get perforated,
d) The edges 3, 4, 3′, and 4′ to take the form of an arch of n sided polygon where n≥3,
e) number of cusp structures ‘x’, where x≥2,
f) direction of the fluid in either axial direction where n≥3.

10. The multiphase(ic) flow as claimed claim 1 selected from a group comprising of liquid-liquid, liquid-gas, liquid-liquid-gas, immiscible solvent systems, highly viscous liquids, liquid-solid, ternary systems, solvent-extraction-systems.

11. The apparatus as claimed in claim 1 for enhanced mixing of a multi-phasic flow that ensures enhanced mass-transfer, heat-transfer and improved dispersion in case of gas-liquid systems with minimal pressure head loss downstream of the injection site.
